(19) United States
(12) Patent Application Publication
(10) Pub. No.: US 2015/0136540 A1
(43) Pub. Date: May 21, 2015

(54) BRAKE VIBRATION DAMPER

(71) Applicant: Trek Bicycle Corporation, Waterloo, WI (US)

(72) Inventor: Gabriel Lucas, Sun Prairie, WI (US)

(73) Assignee: Trek Bicycle Corporation, Waterloo, WI (US)

(21) Appl. No.: 14/335,349

(22) Filed: Jul. 18, 2014

Related U.S. Application Data
(60) Provisional application No. 61/847,703, filed on Jul. 18, 2013.

(51) Int. Cl. F16D 65/00

(52) U.S. Cl. CPC F16D 65/0006
USPC 188/73.35

(57) ABSTRACT

A brake apparatus can include an adapter portion and a weight. The adapter portion can be configured to be coupled to a brake device. The weight can be coupled to the adapter portion by a damper.

### CROSS-REFERENCE TO RELATED PATENT APPLICATIONS

This application claims the benefit of U.S. Provisional Application No. 61/847,703, filed Jul. 18, 2013, titled “BRAKE VIBRATION DAMPER,” [sic] which is incorporated herein by reference in its entirety.

### BACKGROUND

The present invention relates generally to bicycles and, more particularly, to a bicycle brake accessory.

When a bicycle brake activates, vibrations can be induced into the brake and brake holding structure. The vibrations can cause undesirable ride feel and undesirable handling characteristics. Thus, improved methods and devices for reducing vibration when activating brakes are needed.

### SUMMARY

One illustrative embodiment is directed to a brake apparatus. The brake apparatus can include an adapter portion and a weight. The adapter portion can be configured to be coupled to a brake device. The weight can be coupled to the adapter portion by a damper.

Another illustrative embodiment is directed to a brake apparatus. The brake apparatus can include a brake device and a weight. The weight can be coupled to the brake device by a damper.

Another illustrative embodiment is directed to a brake apparatus. The brake apparatus can include a brake device and a weight. The brake device can include a brake element. The weight can be coupled to the brake element by a damper.

It is appreciated that the aspects and features of the invention summarized above are not limited to any one particular embodiment of the invention. That is, many or all of the aspects above may be achieved with any particular embodiment of the invention. Those skilled in the art will appreciate that the invention may be embodied in a manner preferential to one aspect or group of aspects and advantages as taught herein. These and various other aspects, features, and advantages of the present invention will be made apparent from the following detailed description and the drawings.

### BRIEF DESCRIPTION OF THE DRAWINGS

The drawings illustrate preferred embodiments presently contemplated for carrying out the invention.

FIG. 1 is an elevational view of a bicycle in accordance with an illustrative embodiment.

FIG. 2 is a side view of a brake vibration damper assembly 200 in accordance with an illustrative embodiment.

FIG. 3 is an exploded perspective view of the brake vibration damper assembly 200 of FIG. 2 in accordance with an illustrative embodiment.

FIG. 4 is a side view of a rear bicycle frame with a brake vibration damper assembly 400 in accordance with an illustrative embodiment.

FIG. 5 is a rear view of the rear bicycle frame with a brake vibration damper assembly 400 of FIG. 4 in accordance with an illustrative embodiment.

FIG. 6 is a perspective view of the rear bicycle frame with a brake vibration damper assembly 400 of FIG. 4 in accordance with an illustrative embodiment.

FIG. 7 is a side view of a fork with a brake vibration damper assembly 700 in accordance with an illustrative embodiment.

FIG. 8 is a rear view of the fork with a brake vibration damper assembly 700 of FIG. 7 in accordance with an illustrative embodiment.

FIG. 9 is a top perspective view of the fork with a brake vibration damper assembly 700 of FIG. 7 in accordance with an illustrative embodiment.

FIG. 10 is a bottom perspective view of the fork with a brake vibration damper assembly 700 of FIG. 7 in accordance with an illustrative embodiment.

### DETAILED DESCRIPTION OF THE ILLUSTRATIVE EMBODIMENTS

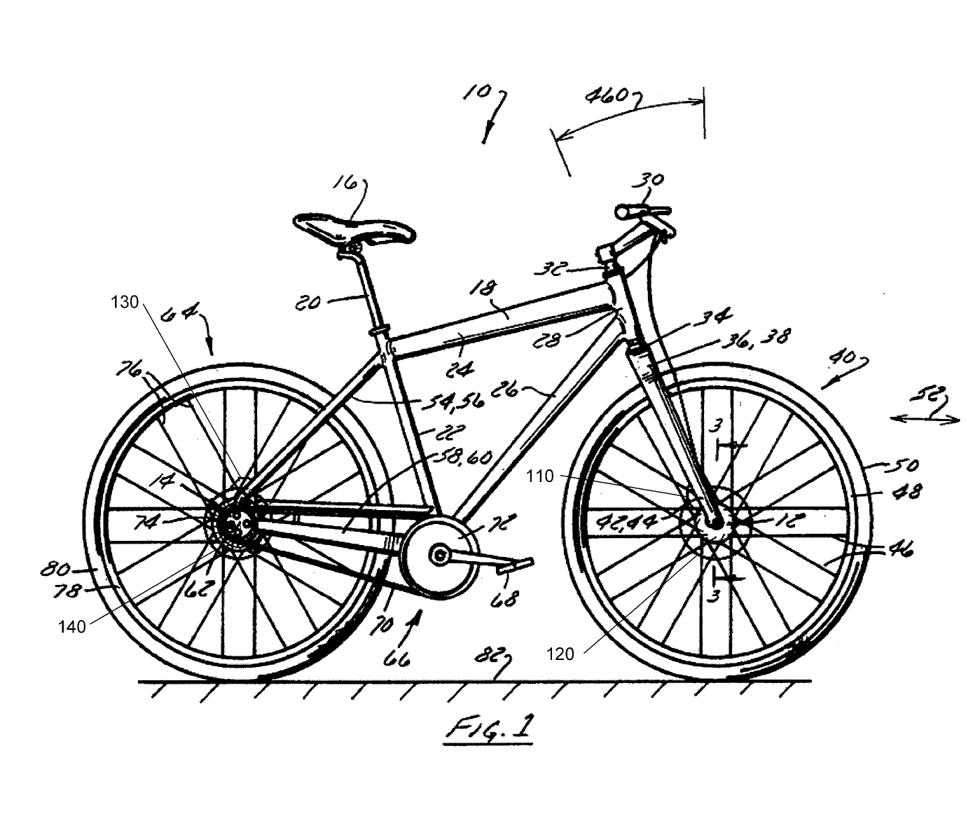

FIG. 1 shows a bicycle 10 equipped with a brake vibration damper assembly. Bicycle 10 includes a seat 16 that is slidably attached to a frame 18. A seat post 20 is connected to seat 16 and slidably engages a seat tube 22 of frame 18. A top tube 24 and a down tube 26 extend forwardly from seat tube 22 to a head tube 28 of frame 18. A handlebar or handlebar assembly 30 is connected to a stem tube 32 that passes through head tube 28 and engages a fork crown 34. The position of handlebar assembly 30 is fixed relative to stem tube 32 and fork crown 34 such that handlebar assembly 30 and fork crown 34 rotate together relative to head tube 28.

A pair of blades 36, 38 of a fork can extend from generally opposite ends of fork crown 34 and are constructed to support a front wheel assembly 40 at an end of each blade, a dropout, or fork tip 42, 44. One of the blades 36, 38 can support a caliper 110. Fork tips 42, 44 can cooperate with generally opposite sides of a front hub assembly 12 so as to secure a front wheel assembly 40 to bicycle 10. The front wheel assembly 40 can include a rotor 120. The caliper 110 and the rotor 120, together, can be a front braking system. A number of spokes 46 extend between front hub assembly 12 and a rim 48 of front wheel assembly 40. A tire 50 is engaged with rim 48 such that rotation of tire 50, relative to forks 36, 38 rotates rim 48, spokes 46, and at least part of front hub assembly 12. Handlebar assembly 30 is connected to bicycle 10 such that side-to-side rotation of the handlebar assembly 30 rotates front wheel assembly 40 relative to a longitudinal axis, indicated by line 52, of bicycle 10 to effectuate steering operation of bicycle 10.

Frame 18 includes a seat stay pair 54, 56 and a chain stay pair 58, 60 that offset an axis of rotation 62 of a rear wheel assembly 64 from a crankset 66. Crankset 66 includes a pair of pedals 68 that is operationally connected to a flexible drive member, such as a belt or a chain 70 via a chain ring(s), or sprocket(s) 72. Rotation of chain 70 communicates a drive force to the rear section of bicycle 10. A cassette or gear cluster 74 is positioned at rear section and cooperates with chain 70. Gear cluster 74 is generally concentrically orientated with respect to axis 62 and preferably includes a number of variable diameter gears. It is appreciated that each of crankset 66 and gear cluster 74 can each be provided with one or more variable diameter gears to facilitate shifting of the power train during use of bicycle 10 so as to alter a pedal force and cadence associated with operation of bicycle 10. One of the seat stay pair 54, 56 can support a caliper 130. The rear wheel assembly 64 can include a rotor 140. The caliper 130 and the rotor 140, together, can be a rear braking system.

Gear cluster 74 is operationally connected to rear hub assembly 14 of rear wheel assembly 64. A number of spokes 76 extend radially between hub assembly 14 and a rim 78 of rear wheel assembly 64. A rear tire 80 is concentrically positioned at a radial outward facing side of rim 78 and is constructed to interact with a riding surface 82. As is commonly understood, rider operation of pedals 68 drives chain 70 thereby driving rear wheel assembly 64 which in turn propels bicycle 10 via the interaction of rear tire 80 with surface 82. It is appreciated that the foregoing description of bicycle 10 is merely exemplary of a bicycle for use with the present invention. It is appreciated that bicycle 10 could be provided in any of a number of configurations including those configurations commonly referred to as street bikes, off-road or mountain bikes, hybrids of these types of bicycles, or other pedal driven vehicle configurations. It is further appreciated that, although the forthcoming description includes disclosure directed to the internal construction of front hub assembly 12, the internal construction of rear hub assembly 14 operates and/or is constructed in a manner similar to front hub assembly 12 unless otherwise noted.

As used herein and as commonly understood in the art, front hub assembly 12 is that portion of front wheel assembly 40 that excludes spokes 46, rim 48, and tire 50 and a securing mechanism that interacts with a respective structure of the front hub assembly 12 and corresponding structure of bicycle 10, such as fork tips 42, 44 so as to secure front hub assembly 12 for rotational operation relative to an underlying bicycle frame 18. Similarly, rear hub assembly 14 forms a portion of rear wheel assembly 64 that does not include spokes 76, rim 78, rear tire 80, and a securing mechanism that interacts with a respective structure of hub assembly 12 and corresponding structure of bicycle 10, such as seat stay 54, 56 and chain stays 58, 60, to secure hub assembly 12 for rotational operation relative to the underlying bicycle frame 18.

Although gear cluster 74 is secured to rear hub assembly 14 so that forward operation of pedals 68 effectuates forward rotation of rear hub assembly 14 which is imparted to rear rim 78 and rear tire 80 via spokes 76, gear cluster 74 is commonly consider a subassembly associated with a drive train of bicycle 10. Said in another way, front hub assembly 12 and rear hub assembly 14 include those portions of front wheel assembly 40 and rear wheel assembly 64 that are radially inboard of the respective spokes 46, 76 and that allow the hub assembly 12, 14 to cooperate with frame 18 to orient the respective hub assembly 12, 14 relative thereto.

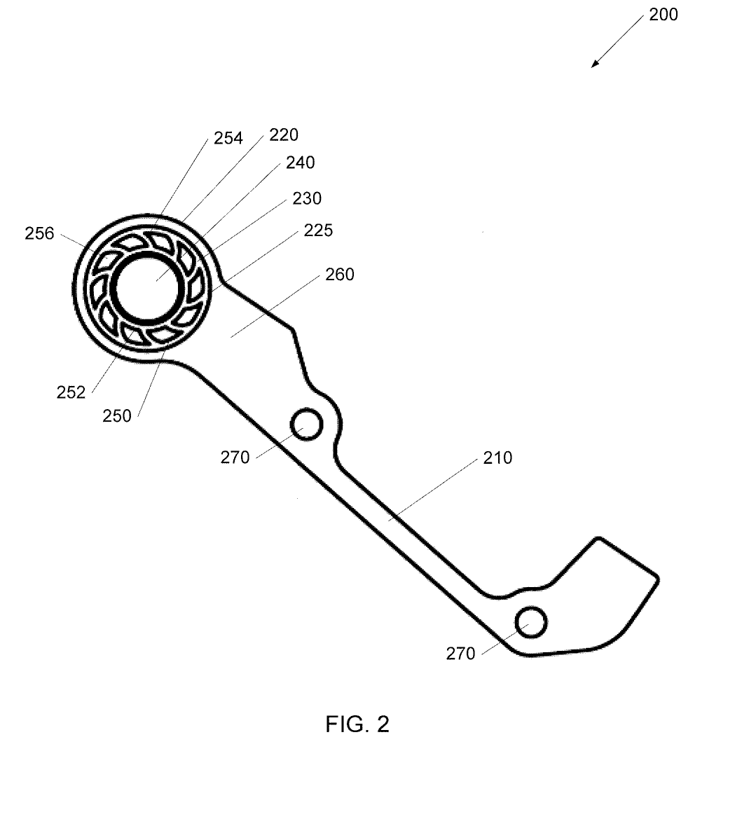

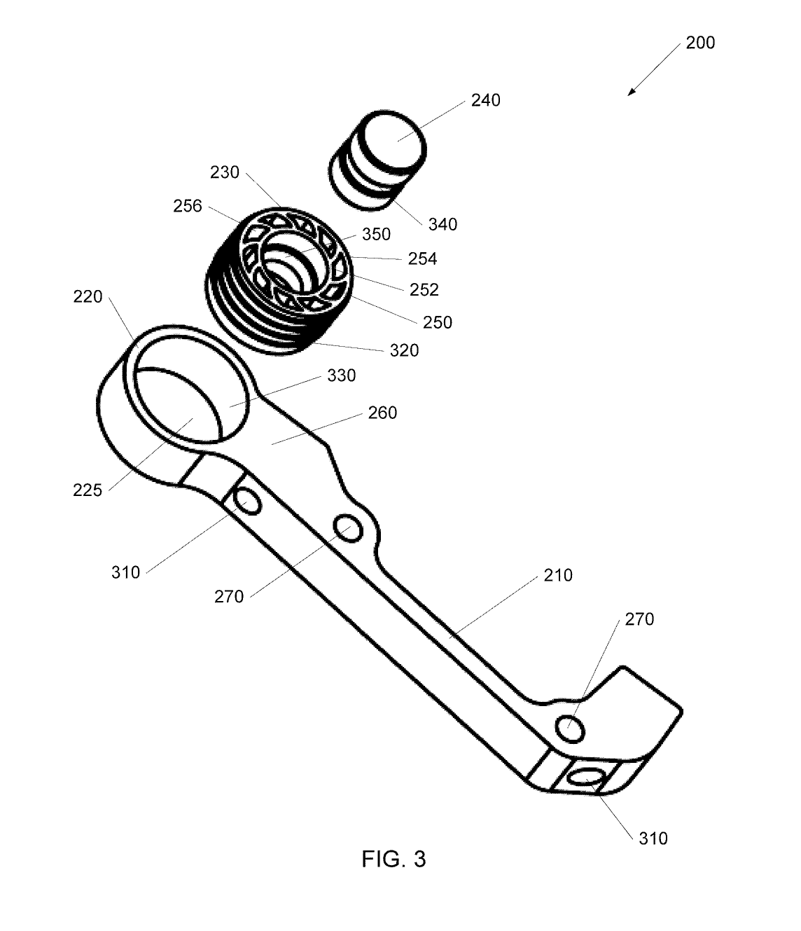

Referring now to FIG. 2, a side view of a brake vibration damper assembly 200 in accordance with an illustrative embodiment is shown. Referring to FIG. 3, an exploded perspective view of the brake vibration damper assembly 200 of FIG. 2 in accordance with an illustrative embodiment is shown. The brake vibration damper assembly 200 can include a brake adapter portion 210, a damper retaining portion 220, a damper 230, and a weight 240.

The brake adapter portion 210 can include chassis mounts 270 and caliper mounts 310. The brake adapter portion 210, the chassis mounts 270, and the caliper mounts 310 can be configured to be a post mount or an international standard mount; however, any mounting style can be used. The brake adapter portion 210 can be made, for example, of metal (such as aluminum, steel, or magnesium), or a fiber reinforced plastic (such as carbon fiber and resin).

The brake adapter portion 210 can be used to adapt a brake to frame of a vehicle such as a bicycle or e-bike. The brake can be, for example, a disc brake, a cantilever brake, a v-brake, a dual pivot brake, a drum brake or any other kind of brake. In one embodiment, the brake vibration damper assembly 200 can be attached to a brake that is already mounted to a frame or already mounted using an adapter. In another embodiment, the brake vibration damper assembly 200 can be integrated directly into a brake assembly or a part of a brake assembly.

The damper retaining portion 220 and the brake adapter portion 210 can be separated by a cantilever portion 260. The length and cross section of the cantilever portion 260 can be tuned to change the damping characteristics of the brake vibration damper assembly 200. In alternative embodiments, damper retaining portion 220 can have any location or orientation with respect to the brake adapter portion 210.

The damper retaining portion 220 can include an opening 225 for securing the damper 230. The opening 225 can include a side groove 330 for retaining the damper 230. The opening can be about 0.25″ deep and about 0.8″ in diameter; however, any size opening can be used. The opening 225 can be through or blind.

The damper 230 can isolate the damper retaining portion 220 from the weight 240. The damper 230 can include an inner ring 252 connected to an outer ring 250 by ribs 254. The inner ring 252, the outer ring 250, and the ribs 254 can form a plurality of damper openings 256. The plurality of damper openings 256 can be open or filled with a second damping material such as a second elastomer. The length, cross section, and number of the ribs 254 can be tuned to change the damping characteristics of the brake vibration damper assembly 200. The damper 230 can be made of an elastomeric material such as rubber. The damper 230 can include outer damper ridges 320 for retaining the damper 230 in the opening 225. The damper 230 can include an inner damper ridge 350 for retaining the weight 240 in the damper 230.

The weight 240 can be a cylinder shape; however, any shape can be used. The weight 240 can be symmetrical or asymmetrical. The weight 240 can be configured to be held by the damper 230. For example, the weight 240 can include a weight groove 340. The weight 240 can be made of a metal such as aluminum, steel, lead, or magnesium. Alternately, the weight 240 can be made of any other material such as plastic, for example, nylon.

In an alternative embodiment, the brake adapter portion can include caliper mounts for mounting to a brake element such as a caliper body but not the chassis. For example, the brake adapter portion can be attached to a non-frame/chassis side of the caliper such as the top, back front, left or right of the caliper. In another alternative embodiment, the brake adapter portion 210 can be integrated into a brake element such as a caliper. For example, opening 225 can be molded into a caliper.

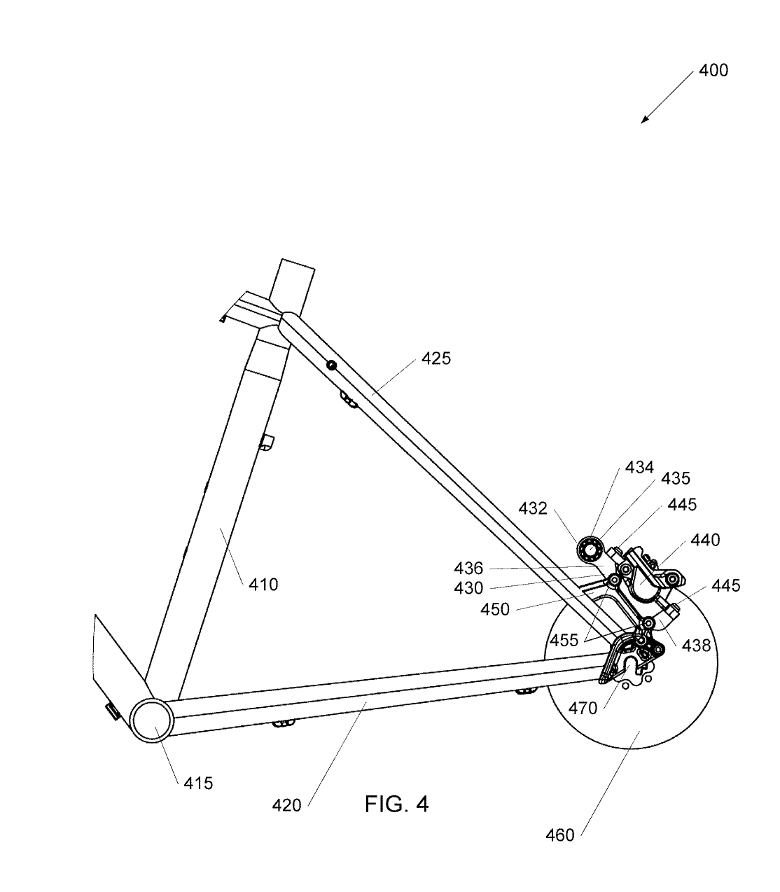

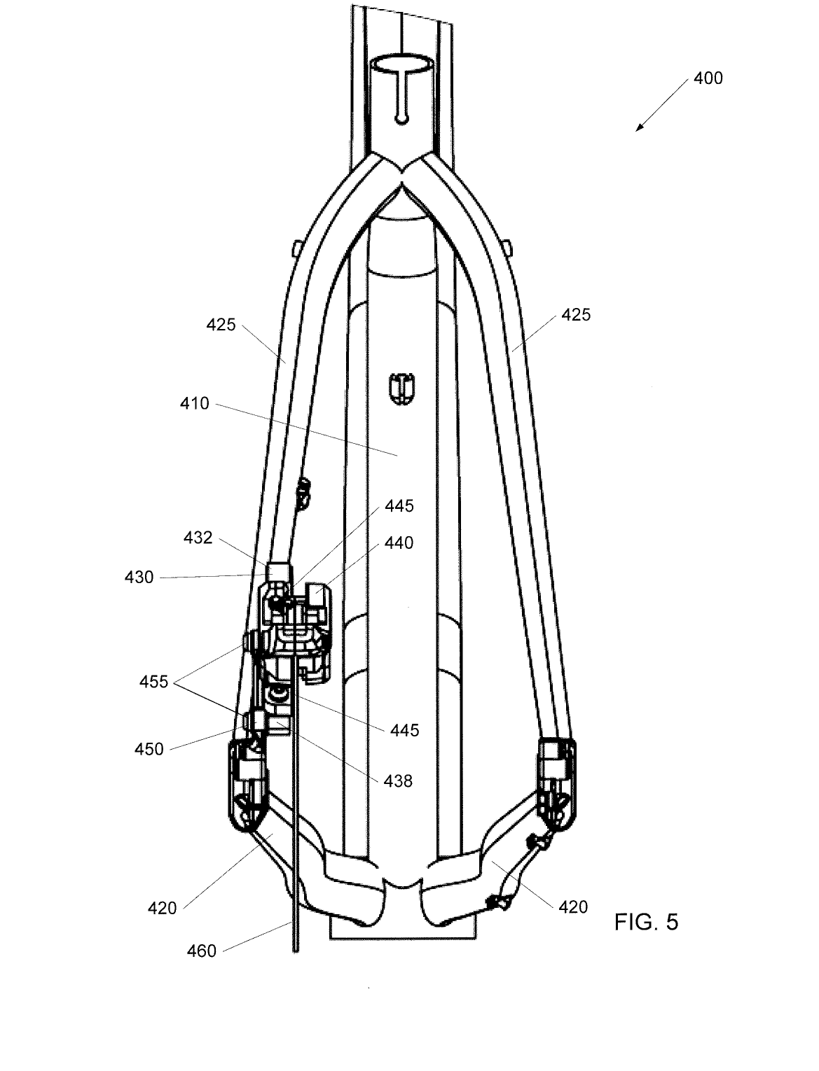

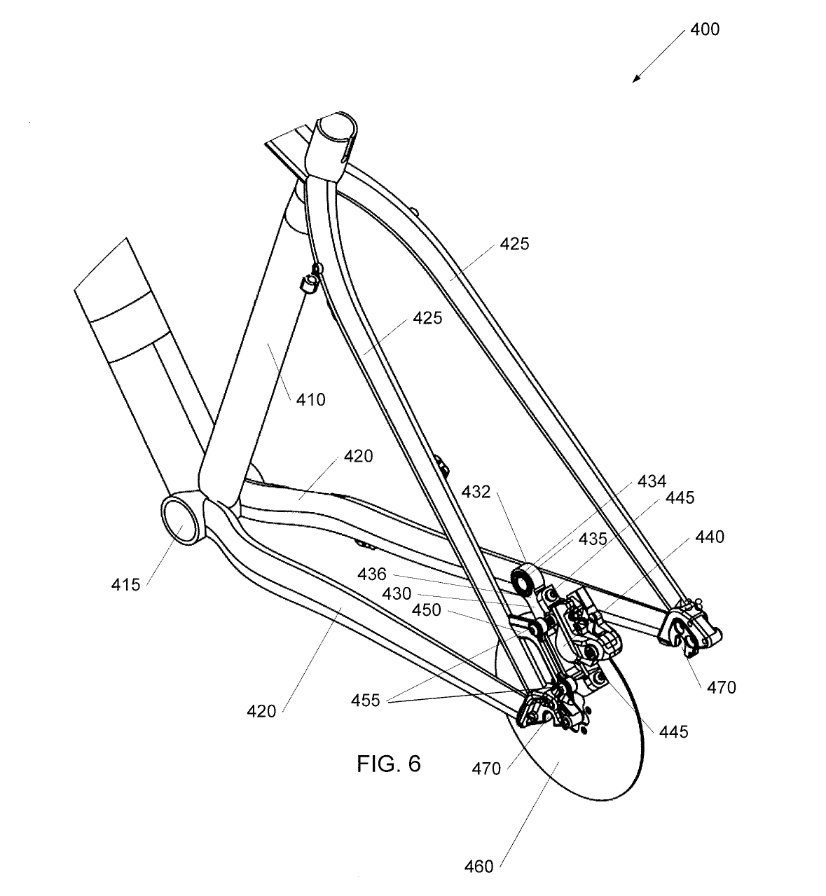

Referring now to FIG. 4, a side view of a rear bicycle frame with a brake vibration damper assembly 400 in accordance with an illustrative embodiment is shown. Referring to FIG. 5, a rear view of the rear bicycle frame with a brake vibration damper assembly 400 of FIG. 4 in accordance with an illustrative embodiment is shown. Referring to FIG. 6, a perspective view of the rear bicycle frame with a brake vibration damper assembly 400 of FIG. 4 in accordance with an illustrative embodiment is shown. The rear bicycle frame with a brake vibration damper assembly 400 can include a seat tube 410, a bottom bracket 415, a chain stay 420, a seat stay 425, a dropout 470, a brake mount 450, a caliper 440, and a rotor 460.

The brake mount 450 can be attached to or part of the seat stay 425. FIGS. 4-6 show an international standard (IS) brake mount 450; however, a post mount or any other brake mount could be used. A brake vibration damper assembly 430 can be coupled to the brake mount 450 using, for example, brake mount fasteners 455. The caliper 440 can be coupled to the brake vibration damper assembly 430 using, for example, caliper fasteners 445. The caliper 440 can be positioned over the rotor 460 such that caliper 440 can actuate on the rotor 460. The rotor 460 can be coupled to a wheel assembly (not shown) that can be secured to the dropout 470.

The brake vibration damper assembly 430 can include a brake adapter portion 438, cantilever portion 436, a damper retaining portion 432, a damper 434, and a weight 435, as described above. When a user actuates the caliper 440 against the rotor 460, energy can be converted and transferred from the rotor 460 to the caliper 440 in the form of heat and kinetic energy. The kinetic energy transferred to the caliper 440 can create vibrations or generate oscillations in the brake mount 450 and, consequently, the chain stay 420 and the seat stay 425. Thus, the vibrations and oscillations can be felt by the user. The brake vibration damper assembly 430 can absorb and dissipate kinetic energy transferred to the caliper 440. The kinetic energy transferred to the caliper 440 can be directed to the damper 434 and a weight 435 via the cantilever portion 436. The weight 435 can counteract the vibrations and oscillations causing damper 434 to absorb and dissipate the vibrations and oscillations.

Advantageously, the user experiences significantly reduced vibrations. Advantageously, the braking response is smoother and improved because of the reduced vibrations and oscillations at the caliper and brake mount.

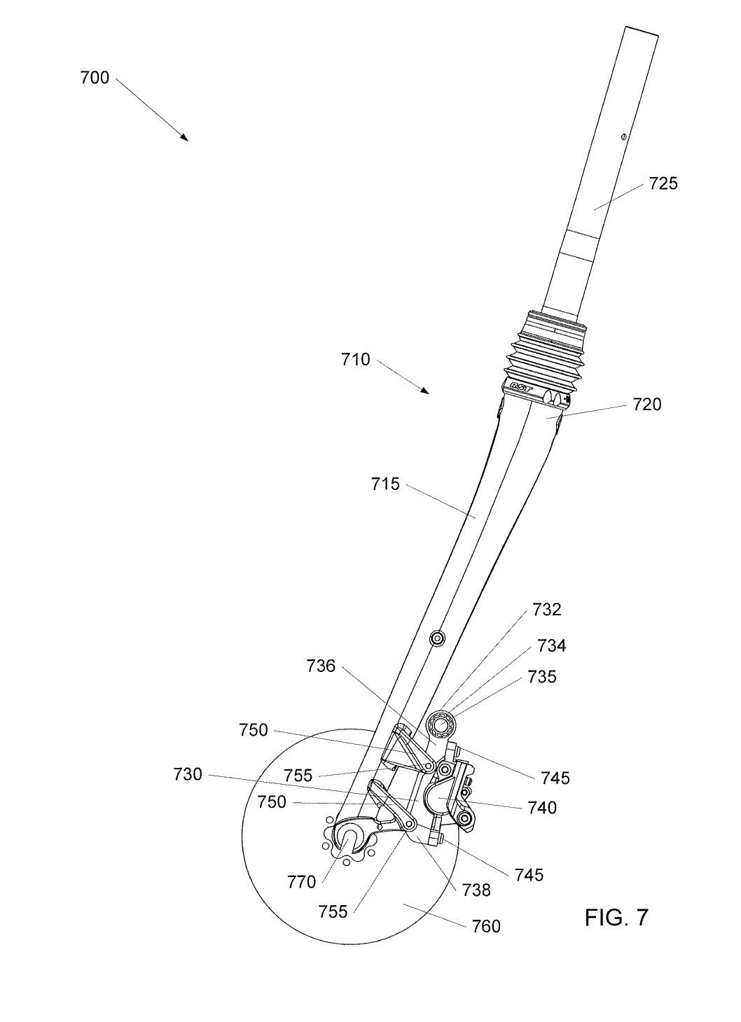

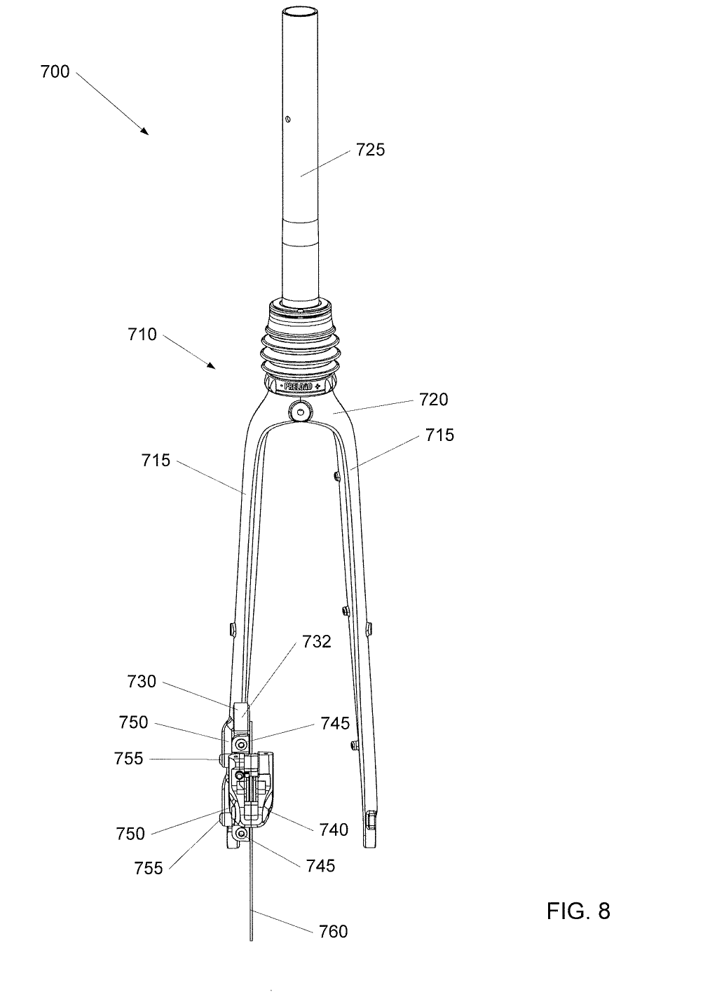

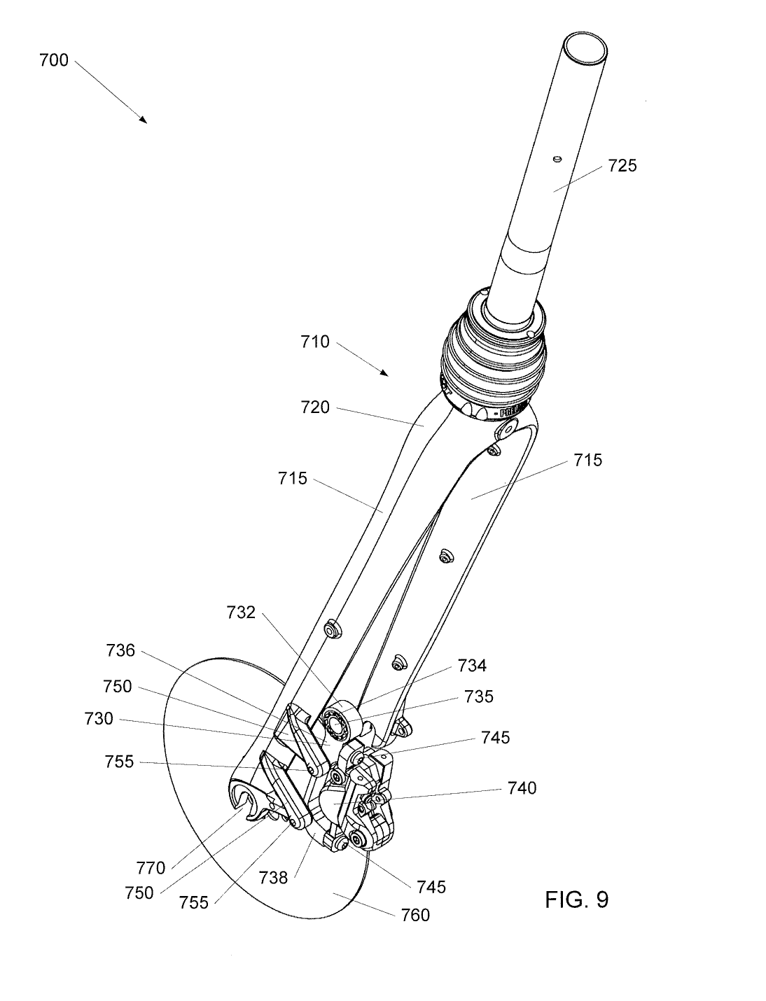

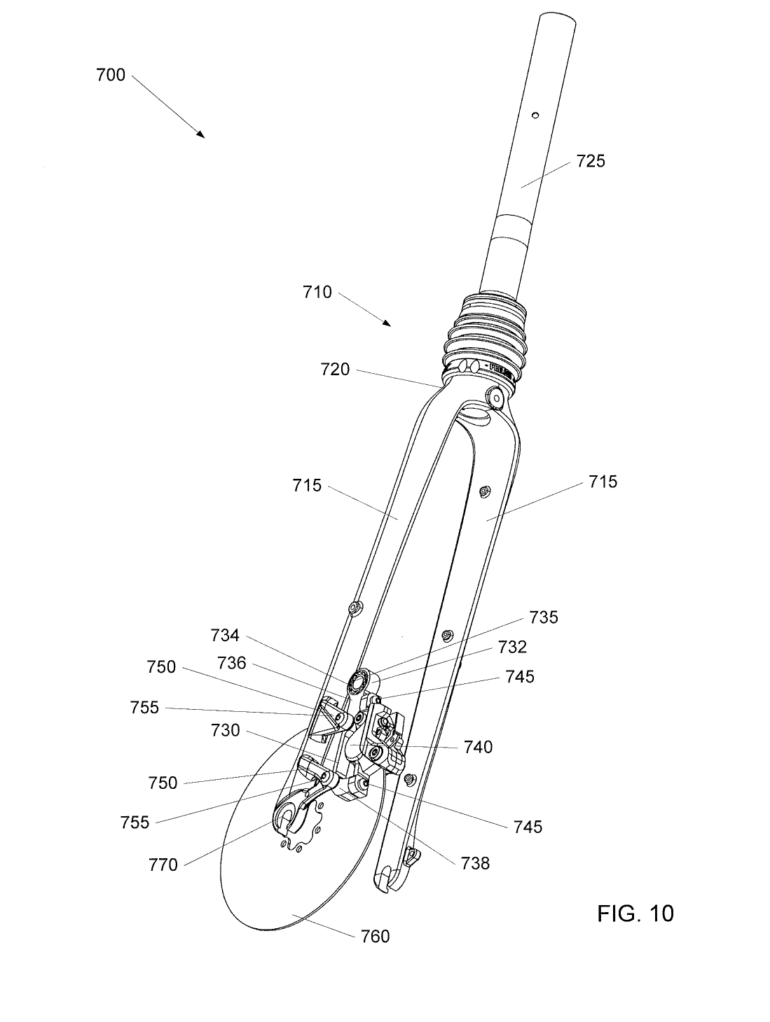

Referring now to FIG. 7, a side view of a fork with a brake vibration damper assembly 700 in accordance with an illustrative embodiment is shown. Referring to FIG. 8, a rear view of the fork with a brake vibration damper assembly 700 of FIG. 7 in accordance with an illustrative embodiment is shown. Referring to FIG. 9, a top perspective view of the fork with a brake vibration damper assembly 700 of FIG. 7 in accordance with an illustrative embodiment is shown. Referring to FIG. 10, a bottom perspective view of the fork with a brake vibration damper assembly 700 of FIG. 7 in accordance with an illustrative embodiment is shown. The fork with a brake vibration damper assembly 700 can include a fork 710, blades 715, a crown 420, a stem 725, a dropout 470, a brake mount 750, a caliper 740, and a rotor 760.

The brake mount 750 can be attached to or part of one of the blades 715. FIGS. 7-10 show an international standard (IS) brake mount 750; however, a post mount or any other brake mount could be used. A brake vibration damper assembly 730 can be coupled to the brake mount 750 using, for example, brake mount fasteners 755. The caliper 740 can be coupled to the brake vibration damper assembly 730 using, for example, caliper fasteners 745. The caliper 740 can be positioned over the rotor 760 such that caliper 740 can actuate on the rotor 760. The rotor 760 can be coupled to a wheel assembly (not shown) that can be secured to the dropout 770.

The brake vibration damper assembly 730 can include a brake adapter portion 738, cantilever portion 736, a damper retaining portion 732, a damper 734, and a weight 735, as described above. When a user actuates the caliper 740 against the rotor 760, energy can be converted and transferred from the rotor 760 to the caliper 740 in the form of heat and kinetic energy. The kinetic energy transferred to the caliper 740 can create vibrations or generate oscillations in the brake mount 750 and, consequently, the blades 715 and the stem 725. Thus, the vibrations and oscillations can be felt by the user. The brake vibration damper assembly 730 can absorb and dissipate kinetic energy transferred to the caliper 740. The kinetic energy transferred to the caliper 740 can be directed to the damper 734 and a weight 735 via the cantilever portion 736. The weight 735 can counteract the vibrations and oscillations causing damper 734 to absorb and dissipate the vibrations and oscillations.

Advantageously, the user experiences significantly reduced vibrations. Advantageously, the braking response is smoother and improved because of the reduced vibrations and oscillations at the caliper and brake mount.

One or more flow diagrams may have been used herein. The use of flow diagrams is not meant to be limiting with respect to the order of operations performed. The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A brake apparatus, comprising:
an adapter portion configured to be coupled to a brake device; and
a weight coupled to the adapter portion by a damper.

2. The apparatus of claim 1, wherein the damper is an elastomer.

3. The apparatus of claim 1, wherein the damper comprises an outer ring, an inner ring, and at least one rib connecting the outer ring and the inner ring.

4. The apparatus of claim 1, wherein the brake device is a caliper and the adapter portion is configured to couple the caliper to a brake mount.

5. The apparatus of claim 4, wherein the brake mount is part of a bicycle frame.

6. The apparatus of claim 4, wherein the brake mount is coupled to a fork.

7. The apparatus of claim 4, wherein the brake mount is coupled to at least one of a seat stay and a chain stay.

8. The apparatus of claim 4, wherein the brake mount is one of an international standard mount or a post mount.

9. The apparatus of claim 1, wherein the adapter portion includes an opening for holding the damper.

10. A bicycle brake apparatus, comprising:
a brake device; and
a weight coupled to the brake device by a damper.

11. The apparatus of claim 10, wherein the damper is an elastomer.

12. The apparatus of claim 10, wherein the damper comprises an outer ring, an inner ring, and at least one rib connecting the outer ring and the inner ring.

13. The apparatus of claim 10, wherein the brake device includes an opening for holding the damper.

14. The apparatus of claim 10, wherein the brake device is coupled to a bicycle frame.

15. The apparatus of claim 10, wherein the brake device is coupled to a fork.

16. The apparatus of claim 10, wherein the brake device is coupled to at least one of a seat stay and a chain stay.

17. A bicycle brake apparatus, comprising:
a brake device including a brake element; and
a weight coupled to the brake element by a damper.

18. The apparatus of claim 17, wherein the damper is an elastomer.

19. The apparatus of claim 17, wherein the damper comprises an outer ring, an inner ring, and at least one rib connecting the outer ring and the inner ring.

20. The apparatus of claim 17, wherein the brake element includes an opening for holding the damper.
